(19) United States
(12) Patent Application Publication
(10) Pub. No.: US 2010/0097892 A1
(43) Pub. Date: Apr. 22, 2010

(54) Ultrasonic Level Detection Device With Flared Section for Reduced Distortion

(75) Inventors: David Aughton, Hawthorn East (AU); Damien Pearson, Hawthorn (AU); Gordon Bish, North Melbourne (AU)

Correspondence Address: SHEPPARD, MULLIN, RICHTER & HAMPTON LLP, 990 Marsh Road, Menlo Park, CA, 94025, US

(73) Assignee: Rubicon Research Pty Ltd., Hawthorn, Victoria (AU)

(21) Appl. No.: 12/516,559

(22) PCT Filed: Nov. 28, 2007
(86) PCT No.: PCT/AU07/01839

§ 371 Date: Dec. 29, 2009

(30) Foreign Application Priority Data
Nov. 28, 2006 (AU) 2006906665

(51) Int. Cl. G01F 23/296; G01K 13/12

(52) U.S. Cl. 367/99; 374/142; 374/E13.001

(57) ABSTRACT

The invention provides a level detection device (32) having a tube (34) which, in use, contains a material (14) for which its level in the tube (34) is to be measured. An ultrasonic transducer (10) is provided at one end of tube (34) for emitting an acoustic waveform that reflects off the surface of the level and returns to the ultrasonic transducer (10) to allow computation of the level from the time periods of the emitted and reflected acoustic waveforms. A flared section (22) within tube (34) diverges from adjacent ultrasonic transducer (10) towards the inside wall of tube (34) above the level, whereby, in use, the measured reflected waveform has substantially reduced signal distortion due to flare (22).

The present invention relates to a level detection device and relates particularly, although not exclusively, to a level detection device for liquid levels.

It is an object of the invention to provide a level detection device which reduces the distortion of a reflected acoustic waveform when level measurement is required within a tube.

With this object in view the present invention provides a level detection device including a tube which, in use, contains a material for which its level in the tube is to be measured, an ultrasonic transducer at one end of said tube for emitting an acoustic waveform that reflects off the surface of said level and returns to said ultrasonic transducer to allow computation of said level from the time periods of said emitted and reflected acoustic waveforms, a flared section within said tube diverging from adjacent said ultrasonic transducer towards the inside wall of said tube above said level, whereby, in use, the measured reflected waveform has substantially reduced signal distortion due to said flared section.

Preferably said tube is circular in cross section and said flared section is conical.

In a preferred embodiment the free end of said flared section is in contact with the inner surface of said tube.

The structure and functional features of preferred embodiments of the present invention will become more apparent from the following detailed description when taken in conjunction with the accompanying drawings, in which:-.

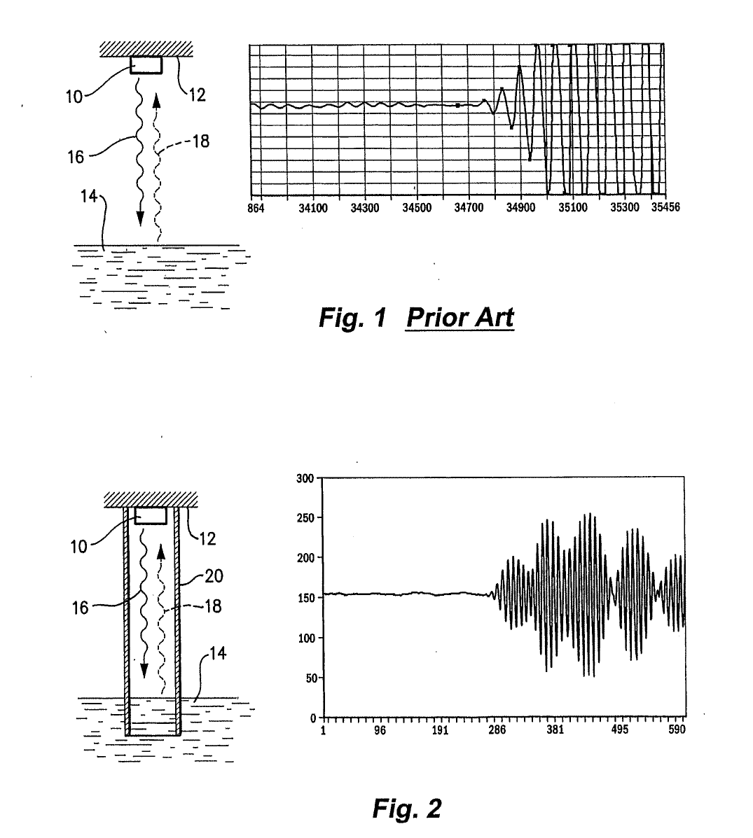

FIG. 1 is a side view of a prior art ultrasonic transducer used to determine water level in an open environment and its resulting acoustic waveform;

FIG. 2 is a similar view to that of FIG. 1 but showing the ultrasonic transducer located within a closed tube and its resulting acoustic waveform;

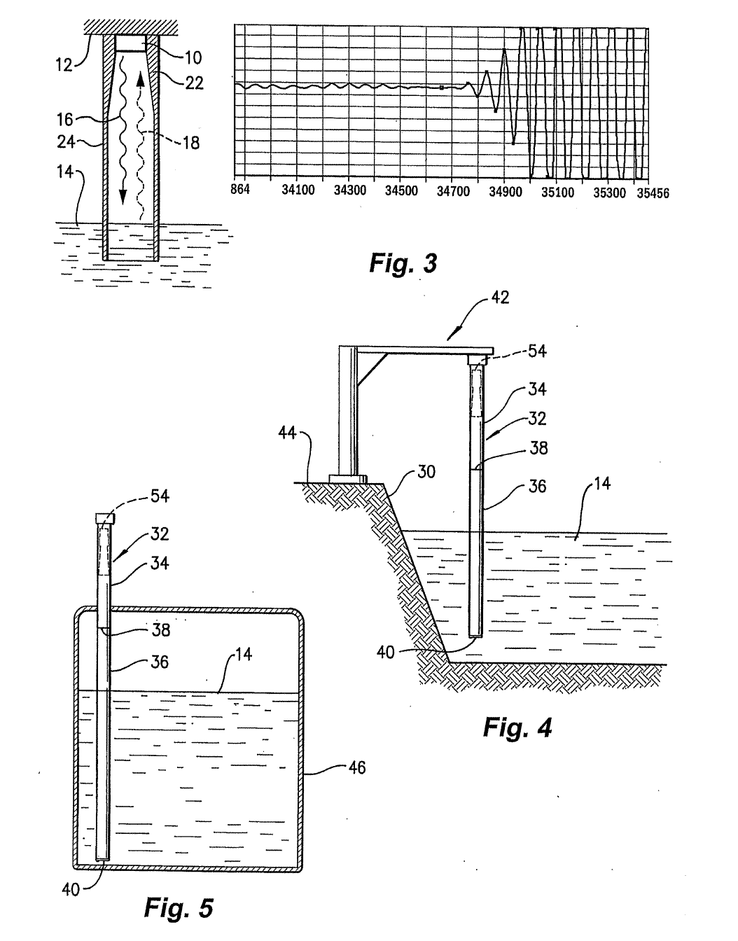

FIG. 3 is a similar view to that of FIG. 2 but showing a level detection device made in accordance with the invention and its resulting acoustic waveform;

FIG. 4 shows the use of the level detection device of FIG. 3 to measure the level of an open channel;

FIG. 5 is a similar view to that of FIG. 4 showing the use of the level detection device of FIG. 3 to measure the level in a closed tank;

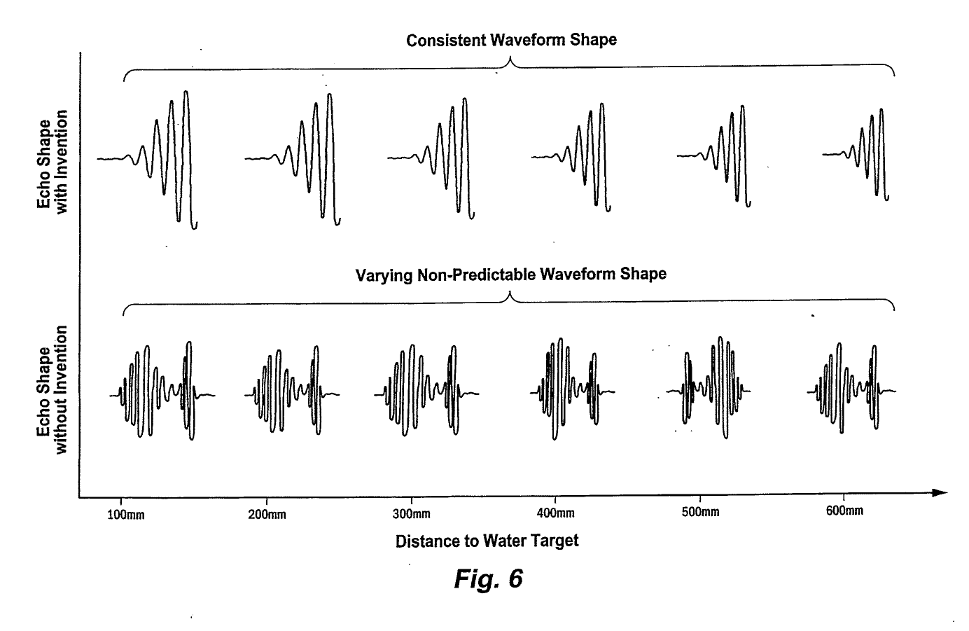

FIG. 6 shows graphs with and without the use of the invention;

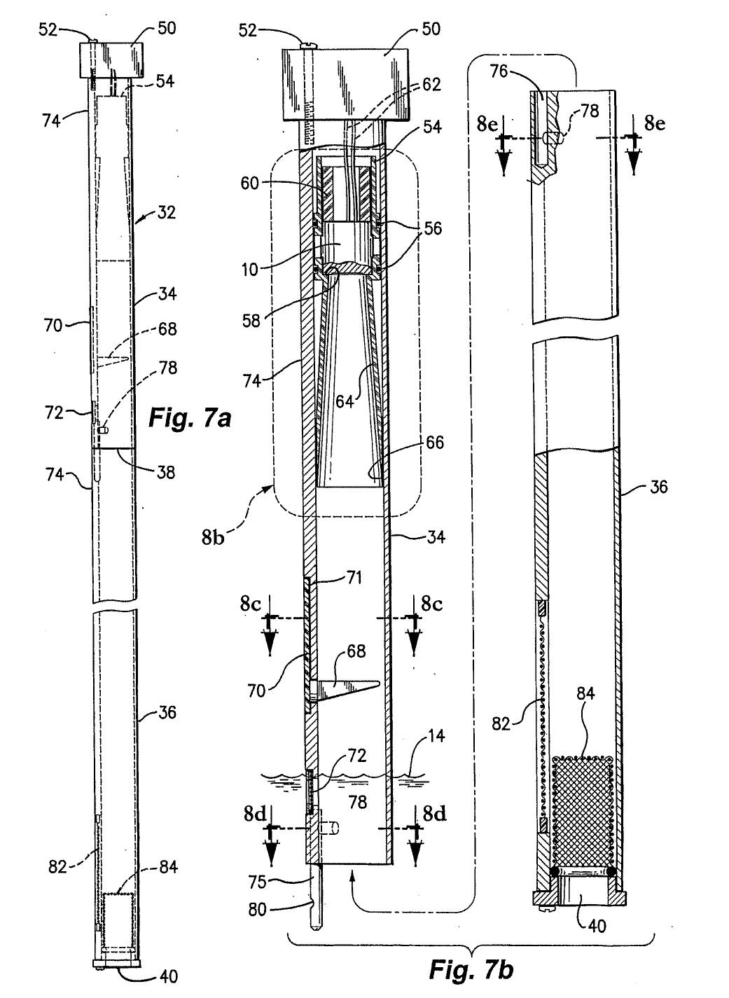

FIG. 7a is a side view of the level detection device shown in FIG. 3;

FIG. 7b is a longitudinal cross-sectional view of the level detection device shown in FIG. 7a showing the components disassembled;

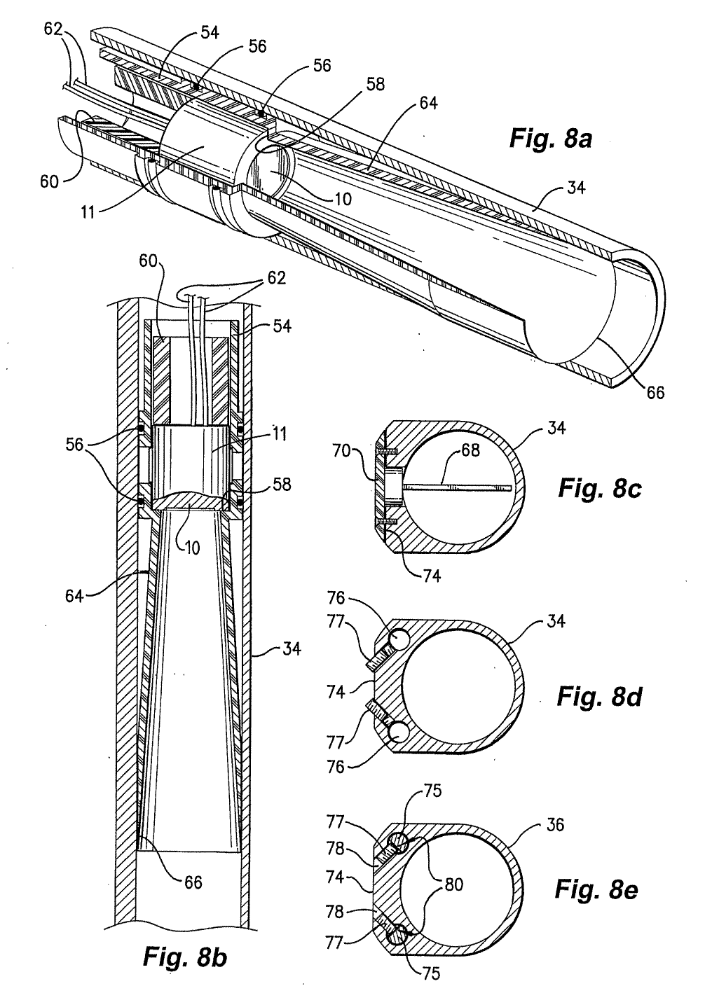

FIG. 8a is a perspective cross-sectional view of the level detection device shown the area indicated by arrow 8b of FIG. 7b;

FIG. 8b is longitudinal cross-sectional view of FIG. 8a;

FIG. 8c is a cross-sectional view along and in the direction of arrows 8c-8c of FIG. 7b;

FIG. 8d is a cross-sectional view along and in the direction of arrows 8d-8d of FIG. 7b;

FIG. 8e is a cross-sectional view along and in the direction of arrows 8e-8e of FIG. 7b;

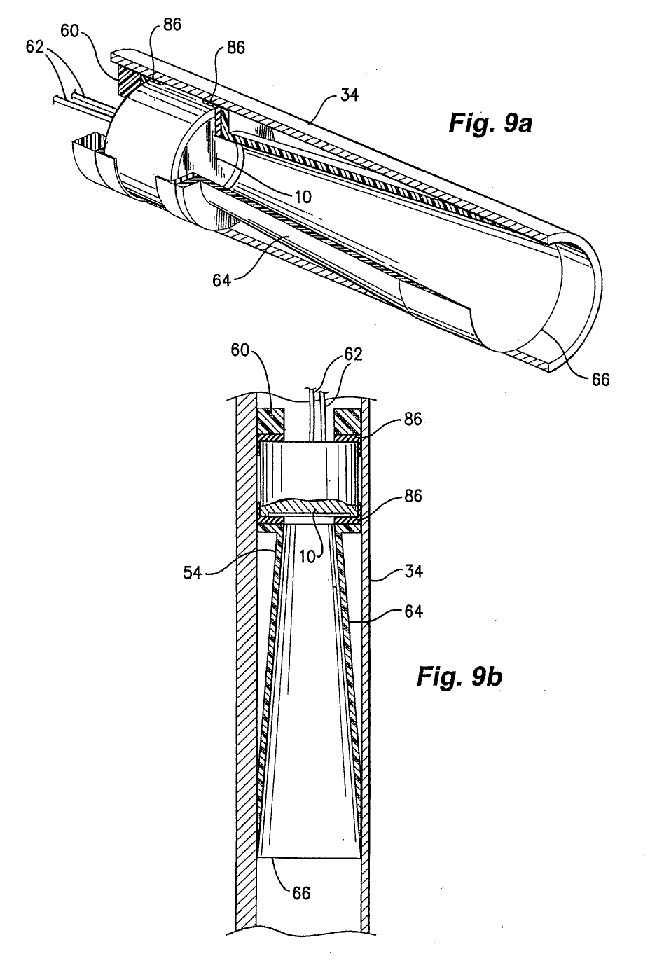

FIG. 9a is a similar view to that of FIG. 8a showing a second embodiment of a level detection device made in accordance with the invention;

FIG. 9b is longitudinal cross-sectional view of FIG. 9a;

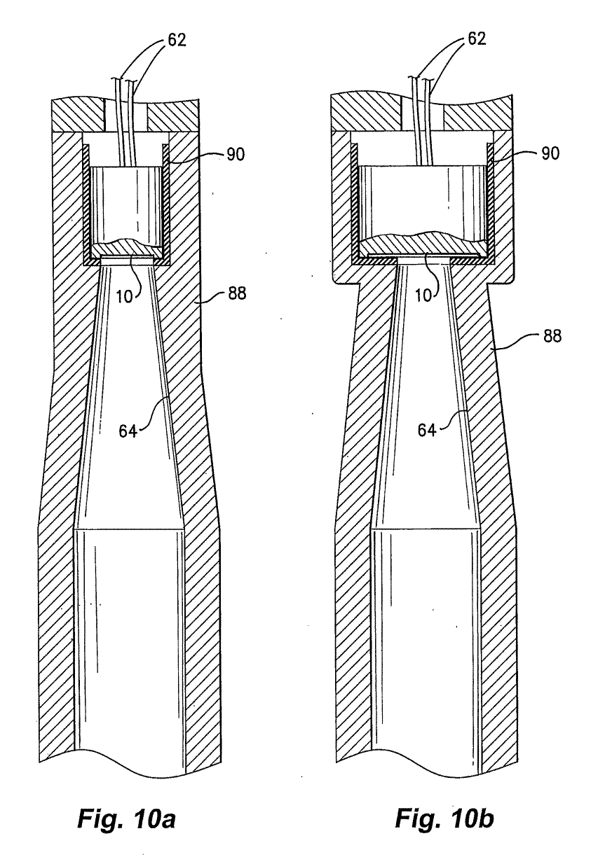

FIG. 10a is a similar view to that of FIG. 9b showing a third embodiment of a level detection device made in accordance with the invention; and

FIG. 10b is a similar view to that of FIG. 9b showing a fourth embodiment of a level detection device made in accordance with the invention.

In order to avoid duplication of description, identical reference numerals will be shown, where applicable, throughout the illustrated embodiments to indicate similar integers.

In FIG. 1 the prior art is shown where an ultrasonic transducer 10 is attached to a support 12 to measure the distance to a surface 14 whether it be solid, liquid or gas. The ultrasonic transducer 10 is typically a piezo-crystal. The piezo-crystal is energized with a periodic high voltage signal, which causes the crystal to expand and in so doing generate an acoustic waveform. The acoustic waveform 16 emitted from the piezo-crystal travels towards the surface at the speed of sound. The acoustic waveform reflects off the a reflective surface 14. The reflected acoustic waveform 18 returns to the piezo-crystal where it converts the reflected acoustic waveform 18 into a voltage which is sampled by electronics (not shown) and converted to a numerical representation of the acoustic waveform. The numerical representations of the reflected acoustic waveform and of the energizing signal are then analyzed. The time period between the energizing signal and the received acoustic waveform signal is measured. This time period is multiplied by the speed of sound to determine the distance between the piezo-crystal and the reflective surface 14. In the open environment shown in FIG. 1 the transmitted acoustic waveform is not distorted by its surroundings. An undistorted waveform is illustrated in the graph accompanying FIG. 1. This non-distorted acoustic waveform has the shape of a rising sinusoid. It is a sinusoidal signal whose amplitude increases with each successive period.

Unfortunately, all measurements cannot be made in an open environment. FIG. 2 shows a similar arrangement but the measurement must be made within a tube 20. The use of acoustic measurement in this closed environment has proved difficult. With the piezo-crystal 10 located within closed tube 20, the sampled reflected acoustic waveform is distorted. The waveform no longer has the shape of a rising sinusoid. The sinusoidal signal amplitude no longer rises with each successive period. An example of the distorted acoustic waveform is shown in the graph accompanying FIG. 2. The shape of the reflected acoustic waveform varies with the distance between the piezo-crystal 10 and reflective surface 14. The reflected acoustic waveform no longer has a predictable shape.

FIG. 3 illustrates a first embodiment of the invention. It has been discovered that the acoustic distortion shown in FIG. 2 can be prevented by a flared surface 22 that creates a smooth transition between the external perimeter of piezo-crystal 10 and the internal perimeter of closed tube 24 within which piezo-crystal 10 is contained. In this embodiment the flared surface 22 is conical in shape. The conical transition surface 22 is adjacent the piezo-crystal 10 and is located above the reflective surface 14. The conical transition surface 22 effects the acoustic properties of the closed tube 24 so that the shape of the returning waveform is constant and repeatable. The shape of the reflected acoustic waveform is shown in the graph accompanying FIG. 3. The distortion shown in FIG. 2 has been removed and the graph is more typical of the non-distorted acoustic waveform in the shape of a rising sinusoid of the graph of FIG. 1. The conical transition surface 22 allows a measurement to be taken within closed tube 24 without signal distortion which was previously not possible.

FIG. 6 illustrates the behaviour of the distorted and non-distorted waveforms. The upper graph shows the use of the invention and the lower graph shows the results without the invention. It is to be noted that the shape of the distorted waveform of the lower graph changes with the distance to the water target, whilst the shape of the non-distorted waveform is consistent irrespective of the distance to the target surface 14.

FIG. 4 illustrates the practical use of the invention with respect to measurement of the water level 14 of an open channel 30. A level detection device 32 made in accordance with the invention comprises a pair of hollow tubes 34, 36 which are joined at 38. Water can enter through the open end 40 and through any other apertures in the tubes 34, 36. The level inside the tubes 34, 36 will correspond with the water level 14 for measurement. The level detection device 32 is secured to a support 42 attached to the top 44 of channel 30. FIG. 5 shows the use of level detection device 32 located within a closed vessel 46 where the top of tube 34 is sealed to the closed vessel 46.

FIGS. 7a and 7b illustrate a practical implementation of the construction of level detection device 32 shown in FIGS. 4 and 5. Tube 34 has an end cap 50 which can be secured to the top thereof by threaded fastener 52 or any other suitable means. A sleeve 54 is inserted into tube 34 and is held in place by O-rings 56 which sealingly engage the inner surface of sleeve 54. The ultrasonic transducer 10 is typically surrounded by a silicone sleeve 11 to reduce vibration and rests on an inner shoulder 58 to be clamped in place by a resilient silicone sleeve 60. The silicone sleeve 11 provides vibration damping and prevents vibration being transmitted between the transducer 10 and the tube 34. The type of ultrasonic transducer 10 used can vary depending on requirements. The preferred embodiment has successfully used the ultrasonic transducers AT225 and AT120 from Airmar Technology Corporation. The wires 62 of ultrasonic transducer 10 emerge from the sleeve 54 and are connected to the operation electronics (not shown). Sleeve 54 has a smooth conical section 64 which diverges from shoulder 58 to meet the inner surface of tube 34. The conical section 64 thins out at the free end 66 to provide a smooth engagement with the inner surface of tube 34. In this embodiment the diameter of the transducer 10 is smaller than the smallest diameter of the conical section 64. Below sleeve 54 is triangular fin 68 which is locked in place by a base 70 which sits in a recess 71 of tube 34. Tube 34, in this embodiment has a flattened surface 74 to allow for easy assembly of the level detection device 32. Fin 68 is used as a reference mark which provides an additional echo in the received signal. The distance from the ultrasonic transducer 10 to the reference mark 68 is precisely calibrated, and the reading is obtained as the ratio of the time of flight of the water level echo to the time of flight of the reference mark echo, multiplied by the distance to the reference mark. This technique allows the level detection device 32 to be effectively self-calibrating. A mesh filter 72 acts as a breather port that allows entry of air and water into tube 34. Tube 34 will be thus be sealed above this breather port to produce an air-locked bell-chamber to protect the reference mark 68, sleeve 54 and transducer 10 from immersion. A pair of pins 75 are locatable in bores 76 of tube 36 to allow the tubes 34, 36 to be linked together positively. The pins 75 can be locked in place by threaded grub screws 77 engaging within threaded bores 78 which mate with cut out 80 on pins 75. Water can only enter tube 36 through mesh filter 82 on the side or through a cylindrical mesh filter 84 at open end 40.

The embodiment shown in FIGS. 9a and 9b is very similar to that shown in FIGS. 7 and 8 but show the use of a larger transducer 10. Transducer 10 has a larger diameter than the smallest diameter of the conical section 64. The transducer 10 and the tube 34 are separated by a pair of rubber isolation bushings 86 which absorb the vibration and prevent excessive resonant vibration duration in the transducer. The isolation bushings 86 reduce the transducer's ‘blanking distance’, which is the distance required for the transducer signal to decay to a quiet baseline after the firing pulses have been generated. Generally an echo cannot be reliably detected within this blanking distance, because it is concealed by the signal still present after the transducer firing event. This embodiment illustrates that the diameter of transducer 10 is not important to operation of the invention.

FIG. 10a is similar to the embodiment shown in FIG. 8a where the active face of transducer 10 is smaller than the smallest diameter of the conical section 64. Sleeve 54 is not required as the tube 34 has been replaced by a one piece housing 88 which incorporates tube 34 and sleeve 54 from FIG. 8a. The housing 88 could be created by die-casting or injection moulding with the conical section 64 integrated therewith. FIG. 10b shows a similar embodiment to that of FIG. 10a where the active face of transducer 10 is larger than the smallest diameter of the conical section 64. In both embodiments the transducer is supported in a rubber isolation bushing. In all embodiments the smooth conical section 64 prevents distortion of acoustic waves within the closed tube.

Changes in appearance and construction can be made to the preferred embodiments within the concepts of the invention. Sleeve 54 can be formed of any suitable material but a plastics material has been found to be preferred. In the preferred embodiments the free end 66 of conical section 64 has a smooth engagement with the inner surface of tube 34. Although this engagement is preferred, contact with the inner surface is not essential as the distortion of the waveform will still be reduced if no contact is made. A conical section 64 is shown but tube 34 could also have a non-circular cross-section. Tube 34 could have ovular, triangular, square, rectangular or other type of cross-section with conical section 64 replaced by a suitable flared section. In the preferred embodiments the included angle for the conical section 64 is 7.8° but the angle could be any angle between 1° and 90°. It is assumed in the embodiments that the temperature of air inside tubes 34,36 is constant. In practice, one or more temperature sensors (not shown) can be inserted inside tubes 34,36 to detect any temperature differentials which may affect the correct computation of the level.

The invention will be understood to embrace many further modifications as will be readily apparent to persons skilled in the art and which will be deemed to reside within the broad scope and ambit of the invention, there having been set forth herein only the broad nature of the invention and certain specific embodiments by way of example.

1. A level detection device including a tube which, in use, contains a material for which its level in the tube is to be measured, an ultrasonic transducer at one end of said tube for emitting an acoustic waveform that reflects off the surface of said level and returns to said ultrasonic transducer to allow computation of said level from the time periods of said emitted and reflected acoustic waveforms, a flared section within said tube diverging from adjacent said ultrasonic transducer towards the inside wall of said tube above said level, whereby, in use, the measured reflected waveform has substantially reduced signal distortion due to said flare.

2. The level detection device of claim 1, wherein said tube is circular in cross section and said flared section is conical.

3. The level detection device of claim 1, further including a sleeve which is located within said tube, said sleeve having said flared section at one end and said ultrasonic transducer is located above said flared section.

4. The level detection device of claim 3, wherein the free end of said flared section is in contact with the inner surface of said tube.

5. The level detection device of claim 3, wherein said ultrasonic transducer is clamped into place to reduce vibration and rests on a shoulder within said sleeve.

6. The level detection device of claim 3, wherein said sleeve includes damping means for said ultrasonic transducer.

7. The level detection device of claim 3, wherein said sleeve sealingly engages said tube.

8. The level detection device of claim 1, wherein the diameter of said ultrasonic transducer is smaller than the smallest diameter of said flared section.

9. The level detection device of claim 1, wherein the diameter of said ultrasonic transducer is larger than the smallest diameter of said flared section.

10. The level detection device of claim 1, further including a fin projecting into said tube to provide a reference mark which provides an additional echo in the reflected acoustic waveforms.

11. The level detection device of claim 1, wherein a plurality of interconnected tubes are provided.

12. The level detection device of claim 1, further including a filter device to filter said material entering said tube.

13. The level detection device of claim 1, further including at least one temperature sensor in said tube to detect the temperature of air within said tube for input into said computation.

14. The level detection device of claim 13, wherein a plurality of said at least one temperature sensors are located at predetermined heights to determine temperature differentials for input into said computation.
